(19) United States
(12) Patent Application Publication
(10) Pub. No.: US 2013/0268837 A1
(43) Pub. Date: Oct. 10, 2013

(54) METHOD AND SYSTEM TO MANAGE INTERACTIVE CONTENT DISPLAY PANELS

(71) Applicants: Jennifer Wai-Fung Braithwaite, Lynnwood, WA (US); Dmitry Titov, Kirkland, WA (US); David Edwin Levin, Kirkland, WA (US); Jian Li, Redmond, WA (US); Daniel Cheng, Kirkland, WA (US); Kenneth Brian Moore, Seattle, WA (US); Prasad Tammana, Kirkland, WA (US)

(72) Inventors: Jennifer Wai-Fung Braithwaite, Lynnwood, WA (US); Dmitry Titov, Kirkland, WA (US); David Edwin Levin, Kirkland, WA (US); Jian Li, Redmond, WA (US); Daniel Cheng, Kirkland, WA (US); Kenneth Brian Moore, Seattle, WA (US); Prasad Tammana, Kirkland, WA (US)

(73) Assignee: GOOGLE INC., Mountain View, CA (US)

(21) Appl. No.: 13/443,103

(22) Filed: Apr. 10, 2012

(51) Int. Cl. G06F 17/00

(52) U.S. Cl. 715/234

(57) ABSTRACT

A method for managing information displayed on a computing device includes automatically creating, using an application executed by a processor of the computing device, an interactive content display panel, wherein the interactive content display panel includes a graphical user interface element associated with HTML content. The interactive content display panel is displayed in front of all other windows displayed in a work area of a display of the computing device. The displaying includes automatically adjusting the size the interactive content display panel, based on updates to the HTML content, and automatically positioning the interactive content display panel in the display, based on the automatic adjustment of the size of the interactive content display panel and based on available space in the work area of the display.

### TECHNICAL FIELD

This disclosure generally relates to methods and systems for displaying and interacting with information in a display of a computing device.

### BACKGROUND

Generally, web browsers do not have the ability to create a window that a user can interact with or watch for updates while working on other tasks. For example, if a user wants to start an online chat session with another use while working on a document, the user would need to have the document editing application and the chat window share the screen space, so the user can watch for new chat messages while not working on the document. This is not an optimal solution, however, because the screen space is under utilized, and because the user has to manage the window positions and sizes of the windows to arrange them properly within the screen, which can be cumbersome. Users can have a document editing application in full screen and periodically return to a chat window to look for updates, but this is not optimal because the user has to switch contexts often. Similar issues may arise, for example, if a user wants to watch a show on a video application while doing work in a document or spreadsheet editing application.

### SUMMARY

According to one general aspect, a system and method may enable an application to show and manage interactive content displays, in a way that draws the attention of a user more prominently than other content, and that allows multiple interactive content displays to be shown simultaneously without interfering with each other.

According to one general aspect, a method for managing information displayed on a computing device includes automatically creating, using an application executed by a processor of the computing device, an interactive content display panel, wherein the interactive content display panel includes a graphical user interface element associated with HTML content. The interactive content display panel is displayed in front of all other windows displayed in a work area of a display of the computing device. The displaying includes automatically adjusting the size the interactive content display panel, based on updates to the HTML content, and automatically positioning the interactive content display panel in the display, based on the automatic adjustment of the size of the interactive content display panel and based on available space in the work area of the display.

According to another general aspect, a system includes a display, a memory configured to store executable code, and a processor operably coupled to the memory, The processor may be configured to execute the code to automatically create, using an application executed by a processor of the computing device, an interactive content display panel, wherein the interactive content display panel includes a graphical user interface element associated with HTML content; and display the interactive content display panel in front of all other windows displayed in a work area of a display of the computing device, wherein the displaying includes: automatically adjusting the size the interactive content display panel, based on updates to the HTML content; and automatically positioning the interactive content display panel in the display, based on the automatic adjustment of the size of the interactive content display panel and based on available space in the work area of the display.

According to another general aspect, a non-transitory computer readable medium has recorded and stored thereon instructions that, when executed by a processor of a computer system, cause the computer system to automatically create, using an application executed by a processor of the computing device, an interactive content display panel, wherein the interactive content display panel includes a graphical user interface element associated with HTML content; and display the interactive content display panel in front of all other windows displayed in a work area of a display of the computing device, wherein the displaying includes: automatically adjusting the size the interactive content display panel, based on updates to the HTML content; and automatically positioning the interactive content display panel in the display, based on the automatic adjustment of the size of the interactive content display panel and based on available space in the work area of the display.

The details of one or more implementations are set forth in the accompanying drawings and the description below. Other features will be apparent from the description and drawings, and from the claims.

### DESCRIPTION OF DRAWINGS

FIG. 1 is an example of a user interface for displaying interactive content display panels in a computer system, according to an example implementation.

FIG. 2 illustrates another example of a user interface for displaying interactive content display panels in a computer system, according to an example implementation.

FIG. 3 is another example of a user interface for displaying interactive content display panels in a computer system, according to an example implementation.

FIGS. 4A and 4B are illustrations of a web browser to provide automatically collapsible and expandable panels in a web based application, according to an example implementation.

FIGS. 5A and 5B are illustrations of a user interface that contains a plurality of expandable and collapsible panels vertically stacked in a panel bar, according to an example implementation.

FIG. 6 is a block diagram illustrating panels according to an example implementation.

FIG. 7 is a diagram illustrating a display of panel as a tabbed web page according to an example implementation.

FIG. 8 is a diagram illustrating docking a panel to a panel bar according to an example implementation.

FIG. 9 is a flow chart illustrating a process for managing interactive content display panels, according to an example implementation.

FIG. 10 shows an example of a computer device and a mobile computer device that can be used to implement the techniques described here.

Like reference symbols in the various drawings indicate like elements.

### DETAILED DESCRIPTION

A browser extension or web application may open small pop-up windows that a user wants to keep visible while using a different application or browsing a different web site. Examples may include separate chat sessions, a calculator, a media player, a stock/sport/news ticker, a task list, or a scratchpad. Scattered pop-up windows, however, are difficult for the user to keep track of. Accordingly, interactive content display panels may be automatically placed along a portion of a display screen (e.g., the bottom) and may operate such that they are always on “top” or in front of other windows.

Additionally, a user generally prefers easy control of chat windows (i.e., finding them, moving them out of the way, etc.). Window management of separate chat pop-ups windows, however, is time consuming. Accordingly, it may save time for users if all panels can be minimized or maximized together.

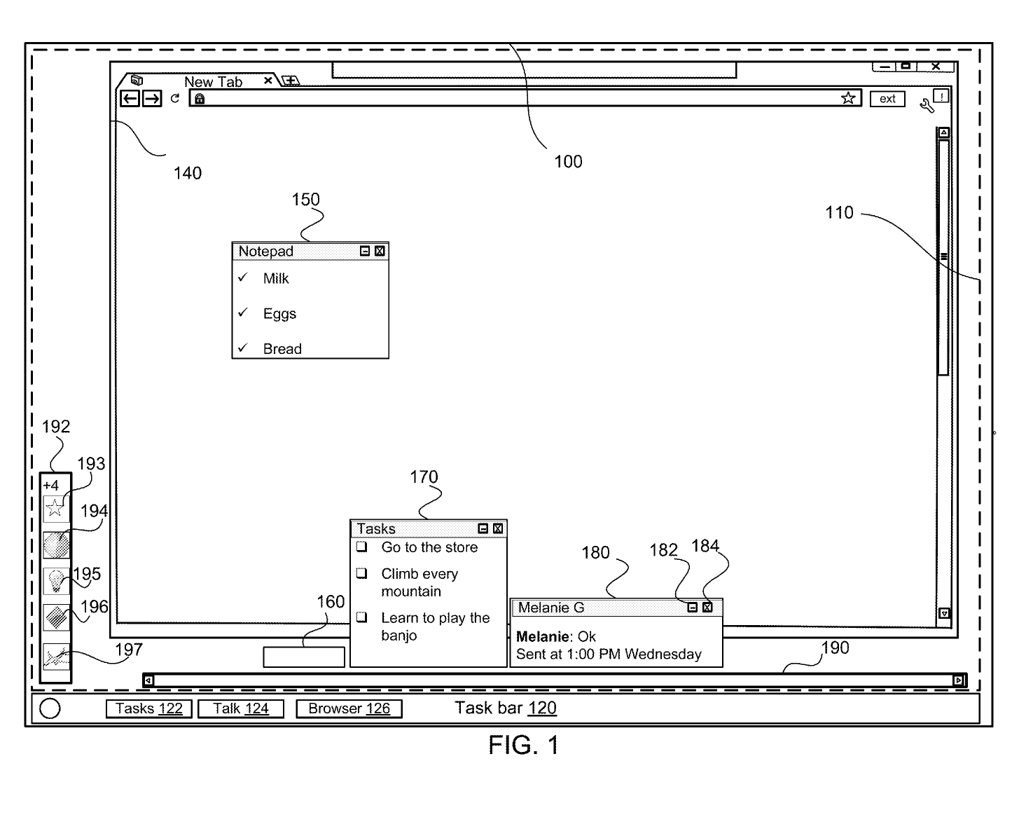

FIG. 1 is an example of a user interface for displaying interactive content display panels in a computer system. As shown in FIG. 1, a display area 100 may include a work area 110 (indicated by a dashed line) and a task bar 120. Work area 110 may be any area of the display area 100 that may be used to place windows, whereas display area 100 may include the entire screen size of a computer display, which includes both work area 110 and task bar 120. In some implementations, work area 110 may extend to the full portion of 100, for example when a task bar 120 is not utilized or when task bar 120 is hidden from view in display area 100.

As shown in the example of FIG. 1, display area 100 may include task bar 120 as part of display area 100, but not part of work area 110. For example, display area 100 may include 1920×1080 pixels, work area may include 1920×1000, and task bar may include 1920×80 pixels along the bottom or side edge of display area 100. The depiction of task bar 120 along the bottom of display area 100 is for illustration only, and one skilled in the art will appreciate that task bar 120 may be positioned along the right side, left side, top, or within any portion of display area. In some implementations, display area 100 may not include any task bar 120, or task bar 120 may be hidden and visible only when a user hovers a cursor over an edge of the display area 100, for example. Browser 140 may be positioned in any portion of work area 110. Browser 140 represents any type of web browser application that allows a user to view websites, and to utilize web applications and browser extensions.

The web browser 140 executed by a client device can receive code (e.g., HTML code) from a remote server (e.g., a remote server that hosts a website) and can execute the received code on the client device for the benefit of a user of the client device.

In various implementations, the web browser 140 may include or be associated with one or more web applications. In this context, a “web application” may be configured to perform a single task or multiple tasks for a user. In such an implementation, the web application may be configured to be executed or interpreted by the web browser 140. This is compared with native applications that include machine executable code and are configured to be executed directly by a processor or via the operating system of the client device, whereas a web application may be incapable of execution or display without the aid of the web browser. Thus, web applications can be run inside the browser 140 with a dedicated user interface, and typically provide functionality and an experience that is more rich and interactive than a standalone website but less cumbersome and monolithic than a desktop application. Examples of web applications include games, photo editors, and video players that are run inside the browser.

Web applications can be “hosted applications” or “packaged applications.” Hosted applications may include at least a portion of a web site that itself includes web pages, plus some metadata that may be especially pertinent to the web application or to the user of the web application to allow the web application to perform some particular functionality for the user. Packaged applications can be thought of as web applications whose code is bundled, so that the user can download all of the content of the web application for execution by the browser. A packaged web application may not need to have network access to perform its functionality for the user, and rather may be executed successfully by the browser locally on the computing device without access to a network. Packaged web applications have the option of using Extension APIs, allowing packaged applications to change the way the browser behaves or looks.

In various implementations, the web browser may include or be configured to interact with one or more browser extensions. In this context, a “browser extension” may include one or more web pages packaged or grouped together as a definable whole, and configured to extend the functionality to the web browser. Thus, extensions also provide extra functionality to a browser, but generally, unlike applications, there is little or no user interface component to the functionality provided by an extension. Instead, web extensions extend the functionality of the browser and the websites being viewed in it. For example, web extensions can extend the functionality of the browser by adding a new button to the address bar, such as an ever-present currency converter. Buttons like this can also apply to the current website being viewed—for example, clicking the currency converter button can convert all prices on the website presented to a user into a currency chosen by the user. In another example, an extension can be installed so that when a user hovers a cursor over a thumbnail image on a webpage executed by a browser a larger-size version of the image is displayed until the user moves the cursor away from the image. In another example, and extension may be installed to embed a “mail this” button next to every link in every page. Compared to web applications, extensions cut across websites and web applications. Extensions are usually in effect across all websites (though some are site-specific). Web applications do not combine with other applications in this way. Rather, web applications run standalone, like any regular website.

When installable web applications are “installed” by the user, the web applications may be added to and integrated with the user's web browser. Installation can include adding a shortcut to an application launcher area of the browser 140. An installation also allows web applications to obtain increased privileges without having to prompt the user for each one individually. Special user interface treatments may apply for the web application's tabs or windows. “Installing” a web application may include integration with: a client's operating system's task and window managers for easy window switching, a taskbar or quick-launch system, interoperating system notification(s), or persistently running background processes. Uninstallation allows for easy removal or deactivation of an installed application from the user's browser or system, and may include revoking all associated privileges. A server-side flag can be used to disable applications remotely. “Installation” may include a user action (e.g., selection of a link or icon), fetching the data to be installed (e.g., downloading data), and processing the data so that the application appears locally (e.g., in an application launcher).

Task bar 120 may include icons, such as icons 122, 124, and 126, which may correspond to applications, web applications, browser extensions, or start up menus of a computing device's operating system. For example, icon “browser” 126 may correspond to browser 140, such that when icon “browser” 126 is selected, browser window 140 may be minimized or opened. Similarly, icon “tasks” 122 may correspond to an interactive content display panel related to tasks, (e.g., panel window 170, discussed in more detail below), and icon “Talk” 124 may correspond to an interactive content display panel for a chat application (e.g., panel 180, discussed in more detail below). Interactive content display panels do not need to be associated with any icons in a task bar, however, and may operate without an associated icon.

Interactive content display panels 150, 160, 170, and 180 (which may also be referred to as simply “panels” throughout this disclosure) are movable graphical user interface elements that may include content, such as any web content that appears within browser 140. Such content may include JavaScript, text, HTML, images, icons, or other content.

Interactive content display panels 150, 160, 170, and 180 are movable and adjustable, and may be automatically created, positioned, sized, and adjusted directly by a processor of a computing device, or by any application executed by the processor, for example by browser 140. A chat application, game, notepad, calculator, media player, word processing application, email application, or any other application may automatically create interactive content display panels. The location of interactive content display panels 150, 160, 170, and 180, as shown in FIG. 1, is for illustrative purposes only. As explained in more detail below, interactive content display panels 150, 160, 170, and 180 may be moved anywhere within work area 110. For example, as shown, interactive content display panel 150 is located within browser 140, whereas panels 160, 170, and 180 are located within work area 110 but between outside of browser 140 and task bar 120. In some implementations, panels may be located on top of task bar 120, or anywhere within display area 100.

Automatic Sizing of Panels

In some implementations, interactive content display panels 150, 160, 170, and 180 can be automatically sized or adjusted based upon the content (e.g., HTML content) within the panels. For example, interactive content display panel 180 may include a person with whom a user chatted (e.g., “Melanie”) and a date and time of the most recent chat (e.g., “1:00 PM on Wednesday”). As illustrated in FIG. 1, the size of an interactive content display panel, such as panel 180, may have a horizontal size wide enough to display the names of people from recent chats. The size of the interactive content display panel 180 can be automatically adjusted based upon the width of the included content, e.g., the name as well as the date and time of the chat. The height and/or width of the interactive content display panel 180 can also automatically adjust based upon the size of the content. For example, as content changes (e.g., chat text increases), the height and/or width of the interactive content display panel 180 can change (e.g., increase or decrease). As another example, the size of panel 150 may increase as a user types more text into the “Notepad” panel 150. Panels may be maximized to a vertical height that is the same vertical height as the work area 110 of the display.

Alternatively or additionally, the size of panels 150, 160, 170, and 180 can change based upon changes in the work area 110. For example, when the resolution of the work area 110 changes (e.g., by a user adjusting the resolution), the size of the panels 150, 160, 170, and 180 can be automatically adjusted based upon the new resolution.

In some implementations, panels 150, 160, 170, and 180 may be minimized to only a few pixels (e.g., 6 pixels) such that they are virtually invisible to a user. Yet, the panels may still have rich interaction while in any minimized state, even if in a few pixels in size, such that they may indicate activity or display a title bar when a user hovers a cursor over a panel or otherwise selects the panel.

As discussed above, in some implementations, the content of an interactive content display panel can be HTML content. The width of the HTML content of a panel may be determined and used as the width of the panel. In implementations where a panel's width is automatically determined based upon content within the panel, a minimum and maximum width can be used to ensure that the panel has at least a minimum and less than a maximum width, regardless of the content within the panel. A vertical height of a panel can also be automatically adjusted or controlled based upon the content of the panel. In some implementations, how a panel is sized is configurable. For example, a configuration option can indicate that the panels are or are not to be auto-sized.

Panel Overflow

A panel overflow mechanism may handle a situation where too many panels are available to fit within work area 110. As example, if the screen size of display 100 is reduced, panels 150, 160, 170, and 180 can be made smaller. As another example, panels 150, 160, 170, and 180 can be made accessible through the use of a horizontal or vertical scrollbar, such as horizontal scrollbar 190 shown in FIG. 1. Scrollbar 190 is optional, and may be added or removed by a user, or may be automatically added based on a number of panels in display area 100.

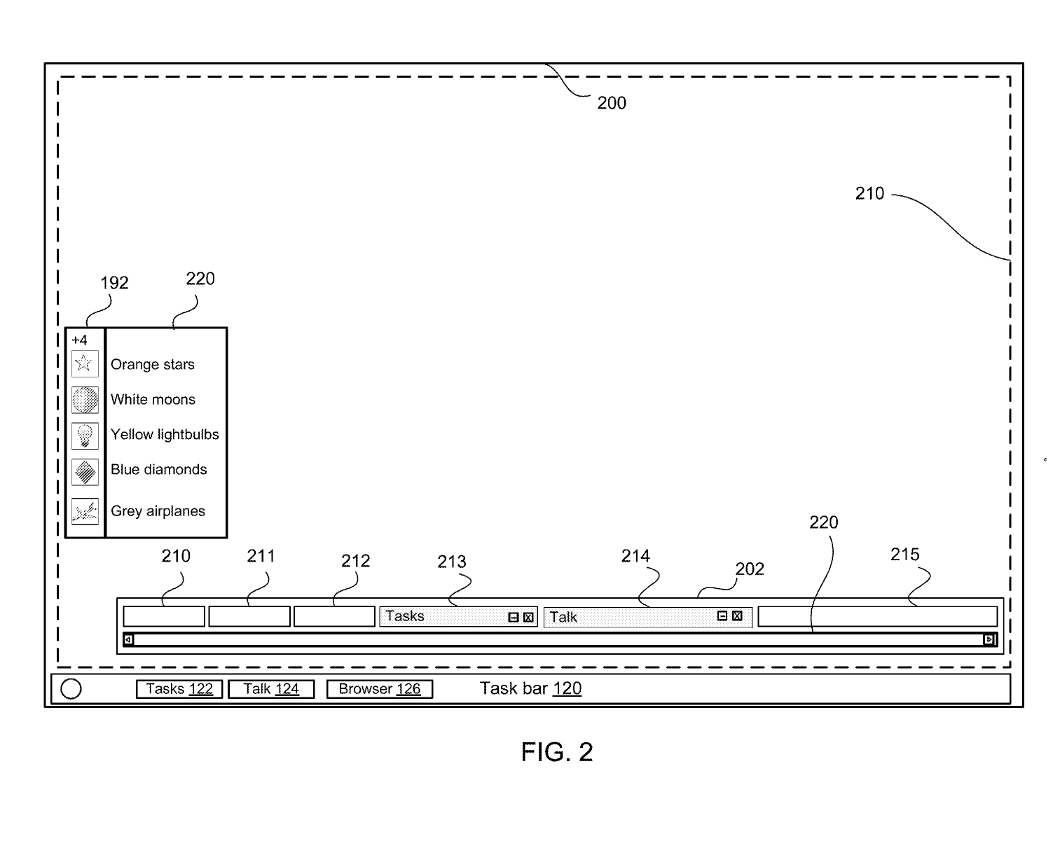

Alternatively or additionally, panels may be made available via an icon overflow strip 192. The icon overflow strip 192 may include icons such as icons 193, 194, 195, 196, and 197, representing various panels, as well as an additional icon or text (e.g., “+4”) representing additional panels (such as a number of panels) not shown in the icon overflow strip 192. In some implementations, the icon overflow strip may be positioned along the left edge of the display screen 100 or work area 110, starting from the bottom, although the position of icon overflow strip 192 is modifiable and the icon overflow strip may be positioned anywhere in display area 100. The icon overflow icon strip 192 may be used to show any or all overflow panels that do not fit within the work area 110. As described in more detail below with respect to FIG. 2, selecting or hovering over any portion of the icon overflow strip 192 may show a titlebar for panels in the icon overflow strip 192, and moving the mouse out of the expanded overflow strip 192 may go back to showing the icons only, as shown in FIG. 1.

Panel Movement

Individual panels can be moved, expanded, minimized, closed, or otherwise adjusted, through interaction with the individual panel. For example, a user may minimize panel 180 by clicking minimize icon 182, or may close panel 180 by clicking close icon 184. In some implementations, a single operation can be performed on two or more panels. For example, all panels can be moved, minimized, expanded, or closed at the same time. In this example, a user can expand all of the panels at once instead of individually expanding each panel. As another example, two or more panels can be selected at a time. An operation can be performed on the selected panel(s). For example, three panels can be selected and then the selected panels can be moved, expanded, minimized, closed, etc., as a group.

Automatic Creation of Panels and Rate of Creation

In some implementations, panels 150, 160, 170, and 180 can be created without user input by various applications, such as, but not limited to, web browser 140, email clients, an operating system, etc. For example, panel 150 may have been automatically created by a notepad web application, and panel 180 may have been automatically created by a chat application. To avoid a large number of panels from being created within a short period of time, the rate of panel creation can be limited. The rate limit can be based upon an originating application of a panel. For example, browser 140 can be limited to creating one panel per second. In such a way, the browser may limit spam or malicious programs.

In another implementation, the rate limit of panel creation can be based upon an originating source that is creating the panels. For example, a particular website can create multiple panels. The panels created by this website can be rate limited (e.g., two panels per second). Multiple rate levels can also be used. For example, a web browser, such as browser 140, can be limited to creating one panel every second and can also be limited to creating ten panels in thirty seconds. In addition, the rate of panel closing can be used to limit the creation of panels. For example, if five panels have been created by a web browser and closed within ten seconds, further creation of panels by the web browser can be limited. In one implementation, the creation of panels is limited such that a web browser can continue to create panels at the limited rate or at a lesser rate. In another implementation, an application can be restricted from creating any further panels once a predetermined limit has been reached.

In yet another implementation, a window manager plugin may be available to manage certain types of panels. The window manager plugin may be provided with an installation of browser 140. The window manager plugin may be written by any third party to provide other features, for example, for managing interactive content display panels.

Panel Bar

FIG. 2 illustrates another example of a user interface for displaying interactive content display panels in a computer system. As shown in FIG. 2, display area 200 may include work area 210 and task bar 120, along with task icons 122, 124, 126. A horizontal panel bar 202 may also be included in a display 200. The horizontal panel bar 202 can include multiple interactive content display panels 211, 212, 213, 214, and 215. In some implementations, a panel may be reduced in size before being docked in the horizontal panel bar. In other implementations, multiple panels can be docked on top of one another to form a docketed group of panels. Selecting the docketed group can allow the selection of any one of the grouped panels.

In another implementation, a group of panels can be grouped together when expanded. The grouping can be identified through a visual indication such as a shared background color, icon in a title bar, or other visual indication of the grouping. A user can manually add a panel to a group of panels or to the panel bar 202, at any time.

In some implementations, panels can also be grouped based on an application, browser extension, or web application representing the origin of the panel. In another implementation, the size of a panel is not reduced prior to being docked. Instead, multiple panels can be docked, which results in a horizontal panel bar that is larger than a viewable portion of the user interface or work area. To allow access to any of the panels, a horizontal scroll bar 220 can be used. In other implementations, for example where panel bar 202 is arranged vertically, a vertical scroll bar (not shown) can be used. In some implementations, when a panel is closed, other panels may slide to new positions automatically.

In some implementations, as described above with respect to FIG. 1, an icon overflow strip 192 may be displayed. When a user hovers over the icon overflow strip 192, an expanded overflow strip 220 with a titlebar for panels in the icon overflow strip 192 is displayed including titles such as “Orange stars,” “White moons,” “Yellow lightbulbs,” “Blue diamonds,” or “Grey airplanes,” for example. Moving the mouse out of the expanded overflow strip 220 may go back to showing the icons only in icon overflow strip 192, as shown in FIG. 1. Icon overflow strip 192 and expanded overflow strip 220 may be positioned, configured, or moved to appear anywhere in display area 200 (such as the top right corner of display area 200), and in some implementations, icon overflow strip may also be expanded, shrunk, or otherwise modified as desired by a user.

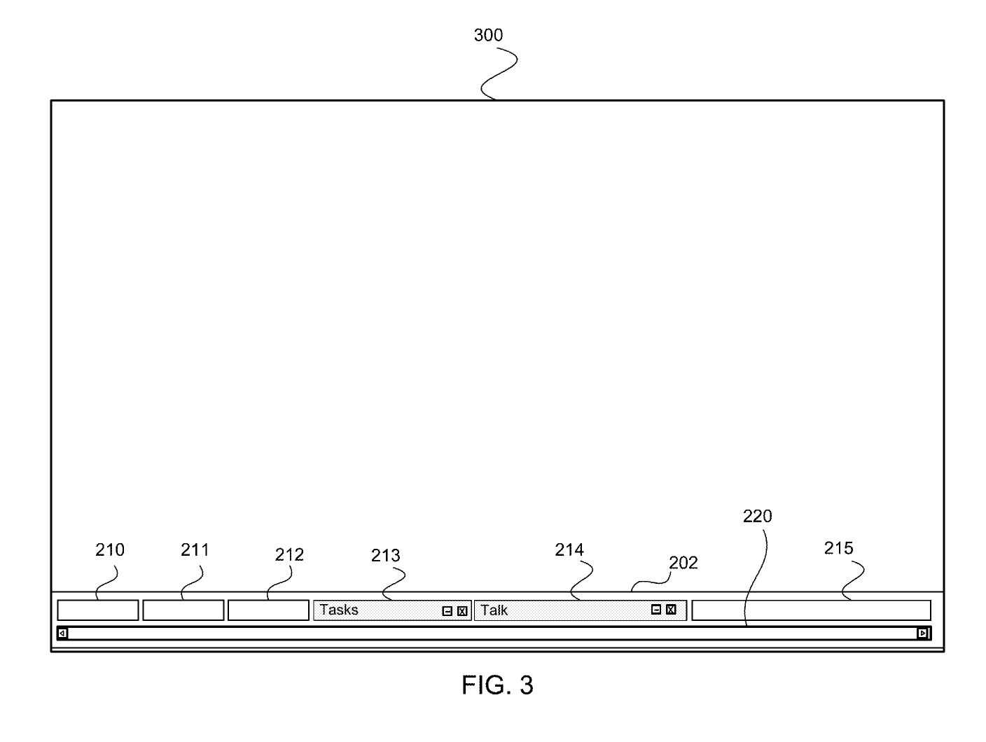

FIG. 3 is another example of a user interface for displaying interactive content display panels in a computer system. FIG. 3 includes display area 300, which includes panels 210, 211, 212, 213, 214, and 215 from FIG. 2. The location of panels 211, 212, 213, 214, 215, or of panel bar 202 can change within display area 300, for example based upon features of an operating system. For example, panels can be docked along any edge of display 300. Some operating systems include a feature of a task bar along the edge of the screen, for example as shown in FIGS. 1 and 2. To not interfere with the task bar or similar feature, panels can be docked along the edge of the task bar 120, as shown in FIG. 2, instead of the edge of the screen or display 200 of FIG. 2. For example, as shown in FIG. 2, panels can be docked immediately above a status bar located at the bottom of display 200. In some operating systems, however, task bar 120 can be partially or fully hidden when not in actively in use. For example, task bar 120 can be hidden when a user's mouse is not positioned near the bottom of the screen. When a user's mouse is moved to the bottom of the screen, the task bar 120 can be automatically expanded. Panels can move in accordance with the task bar. For example, the panels 211, 212, 213, 214, and 215 can be located immediately above the task bar 120, as shown in FIG. 2. As the task bar 120 is hidden or unhidden, the panels may move accordingly. For example, turning back to FIG. 3, when the task bar 120 at the bottom of the screen is hidden, as shown in FIG. 3, the panels may move further down on display 300. Upon restoring the task bar 120, the panels may move up, such that both the task bar 120 and the panels are accessible to the user, as shown in FIG. 2. Of course, for operating systems that do not include a task bar 120, panels may also be displayed as shown in FIG. 3.

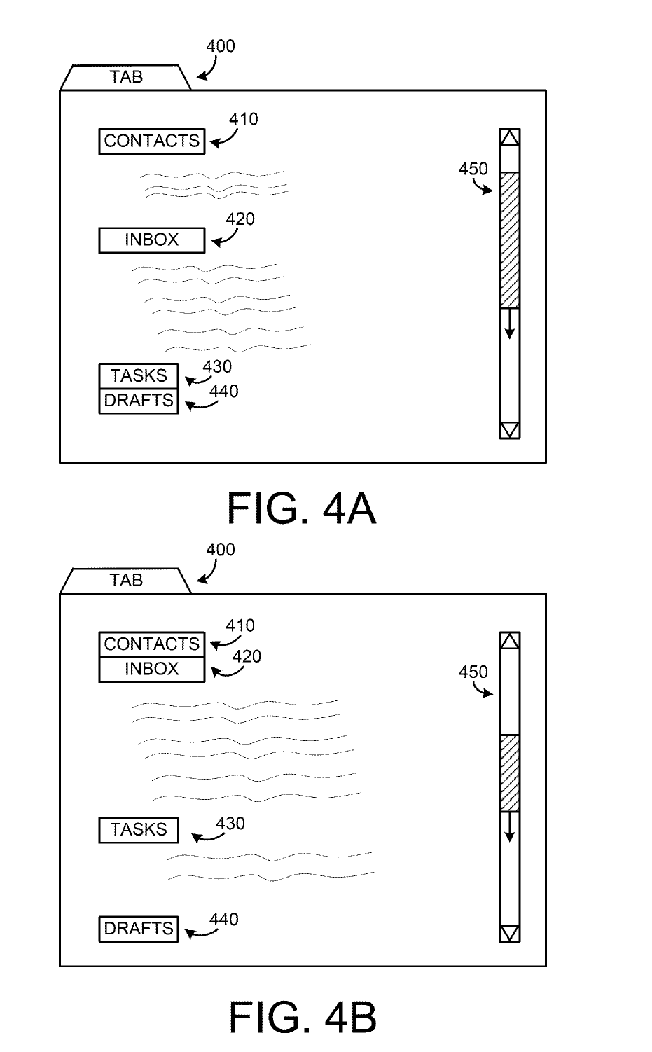

FIGS. 4A and 4B are a schematic illustration of an application, such as a web-browser that provides a user with automatically collapsible and expandable panels in a web based application. In certain web based applications, such as a web-based e-mail application, the a display area of the browser may contain a number of panels within the browser, which may organize information such as emails or contact lists that are displayed to a user. For example, in a web-based email application, “Inbox,” “Draft,” “Sent,” or “Spam” panels can be provided to organize a user's emails. To facilitate navigation of the information contained within these panels, the panels can be made expandable and collapsible. For example, when a user is looking for a particular email he or she has sent, the “Sent” folder can be expanded and the remaining folders collapsed (e.g., by clicking on the panels). These panels, however, can also be automatically expanded or collapsed based on the user's actions within the web browser or user interface.

The use of a web browser herein is used as an illustrative example of applications that may be used in the various implementations. However, other applications may be used as well. As shown in FIG. 4A, an email application (which may, for example be a web-based email application) can provide a number of expandable and collapsible panels 410, 420, 430, and 440, as well as a scroll bar 450 in a tabbed browser window 400. Under each panel, one or more items of interactive content information can be presented. For example, under the “Contacts” panel 410, a plurality of contact documents such as vCards (i.e., electronic business cards) can be stored, while under the “Inbox” panel 420, a plurality of email messages that have been sent to the user can be stored. To facilitate the user's visibility into and access to the information that is stored in the application, one or more of the panels can be expanded by default. For example, all of the panels whose contents are fully or partially displayable within the window 400 can be expanded by default. When a panel is expanded or displayed in its expanded state, one or more information elements that are within the panel may be displayed beneath the panel. Thus, as shown in FIG. 4A, panels 410 and 420 can be expanded since at least one item under each panel is displayable within the window 400, while panels 430 and 440 can be collapsed because none of the items under either panel are currently displayable within the window 400. In some implementations, when a panel is collapsed or displayed in its collapsed state, none of the information elements that are within the panel are displayed beneath the panel.

In one implementation, in order to view the information contained within a collapsed panel, such as the “Tasks” panel 430, the user can manually collapse one or more of the currently expanded panels 410 and 420, and manually expand the “Tasks” panel 430. The user can do this, for example, by clicking on the “Tasks” panel 430 to manually toggle its display state from a collapsed to an expanded state, and by clicking on the “Inbox” panel 420 to manually toggle its display state from an expanded to a collapsed state. Alternatively, as disclosed herein, when a user manually expands a panel, the operating system and/or application (e.g., browser) can automatically collapse other panels that are displayed in their expanded state. For example, when the user clicks on the “Tasks” panel 430 to manually expand it, the operating system and/or browser can automatically collapse the “Contacts” and “Inbox” panels 410 and 420 to maximize the screen area in the window 400 that can be used to display the information elements under the “Tasks” panel 430. Moreover, as the user scrolls down the window 400, the operating system and/or browser can receive information about the user's movement within the user interface and/or browser window 400 and can use that information to automatically expand and collapse one or more of the panels 410-440.

As shown in FIG. 4B, as a user scrolls through the items in an expanded “Contacts” panel 410, the operating system and or web browser can move the items under the “Contacts” panel 410 upward, and can eventually move them off-screen. When the user has scrolled through all of the items under the “Contacts” panel 410, the operating system and/or browser can automatically collapse the panel but continue to display its title. When the operating system and/or browser automatically collapses the “Contacts” panel 410 as described above, it can display the “Inbox” panel 420 directly beneath the “Contacts” panel 410. As the user scrolls through the information elements under the expanded “Inbox” panel 120, the operating system and/or browser can similarly move the information elements in the “Inbox” panel 420 upward and eventually off-screen. As with the information elements under the “Contacts” panel 410, when the user has scrolled through all of the information elements under the “Inbox” panel 420, the operating system and/or browser can automatically collapse the “Inbox” panel 420 but continue to display its title.

In addition to automatically collapsing panels based on the user's actions within the user interface, the operating system and/or browser can automatically expand panels. For example, as the user scrolls down through the “Contact” 410 and “Inbox” 420 panels, the operating system and/or browser can use information regarding the position of the scroll bar within the window 400 to determine whether any information elements under the “Tasks” panel 430 have become displayable. When at least one such information element becomes displayable, the operating system and/or browser can automatically expand the “Tasks” panel 430 to display that information element beneath the title of the “Tasks” panel. In one implementation, when determining which information elements under a panel are currently displayable within the window 400, the operating system and/or browser can reserve screen space to display the titles of the other panels. For example, when determining which information elements under the “Tasks” panel 430 are currently displayable, the operating system and/or browser can reserve screen space to display at least the titles of the “Contacts” 410, “Inbox” 420, and “Drafts” 440 panels.

The operating system and/or browser can also automatically expand the “Tasks” panel 430 whenever the user has scrolled past the title of that panel. For example, when the operating system and/or browser determines that the user has scrolled past the title of the “Tasks” panel 430, the operating system and/or browser can automatically expand the “Tasks” panel 430 to reveal one or more information elements under the panel. In one implementation, the operating system and/or browser can automatically expand the “Tasks” panel 430 to reveal as many information elements under the “Tasks” panel 430 as possible, beginning with the first information element.

The process described above, i.e., of automatically expanding and contracting an application's panels to facilitate a user's view of information stored in an application, is not limited to application based panels such as the web-based email application's panels described above. Instead, the process can be used to automatically expand and contract other types of panels that can be displayed within any user interface such as a desktop display. A panel may be moved to different locations and may be docked to an edge of the desktop display, e.g., to a panel bar. Panels may also be displayed or positioned in any other suitable way, e.g., aligned in parallel with but not directly against an edge of a desktop display. Desktop user interface panels can contain applications, notifications, browser histories, document lists, music play lists, chat histories and user generated content such as pop-up windows. For example, a Talk application (which may be a chat application), can be docked as a panel in a desktop user interface on a computer display. When expanded, the “Talk” panel can reveal a list of chats the user has had with other users using the “Talk” application, as well as metadata about the chats (e.g., with whom they were conducted), and the content of the chats themselves. Similarly, the “Docs” application (which may be a word processing application) can be docked as a panel to the side of a desktop user interface on a computer display. When expanded, the “Docs” panel can reveal a list of documents the user has created, reviewed or edited using the “Docs” application or any other document creation and viewing application. The documents in the list can be stored locally on the user's computer, or remotely on a network or cloud-based server.

In general, the operating system and/or browser can automatically expand and collapse desktop user interface panels based on a user's activity within or movement through the desktop user interface. For example, as explained above, the operating system and/or browser can determine whether to automatically expand or collapse a panel based on the position and movement of a scroll bar within the user interface or based on the position and movement of a cursor representing a pointing device (e.g., a mouse) within the user interface. The operating system and/or browser can receive information about the current position of a scroll bar or cursor within the user interface, and can automatically expand one or more panels to reveal the information elements that are contained within those panels as described above. For example, if a user selects (e.g., clicks on) a panel with a pointing device, the operating system and/or application (e.g., browser) can expand that panel to reveal its information elements to the user. In doing so, the operating system and/or browser can automatically collapse other panels to reveal more content from the panel selected by the user. Similarly, as a user scrolls through the desktop user interface, the operating system and/or browser can determine from the position of the scroll bar when at least one information element within a panel becomes displayable, and can automatically expand the panel when such a determination is made.

The operating system and/or application (e.g., browser) can also automatically collapse one or more panels based on the position and movement of a scroll bar or cursor representing a pointing device within the user interface. For example, the operating system and/or browser can automatically collapse all panels except for a panel the user selects (e.g., clicks on) with a pointing device. The operating system and/or browser can also determine, based on the position of a scroll bar within the user interface, when none of the information elements within a panel are currently displayable within the user interface, and can automatically collapse the panel when such a determination is made. Similarly, as described above, the operating system and/or browser can automatically collapse a panel when a user has scrolled through all of the information elements that are contained within that panel.

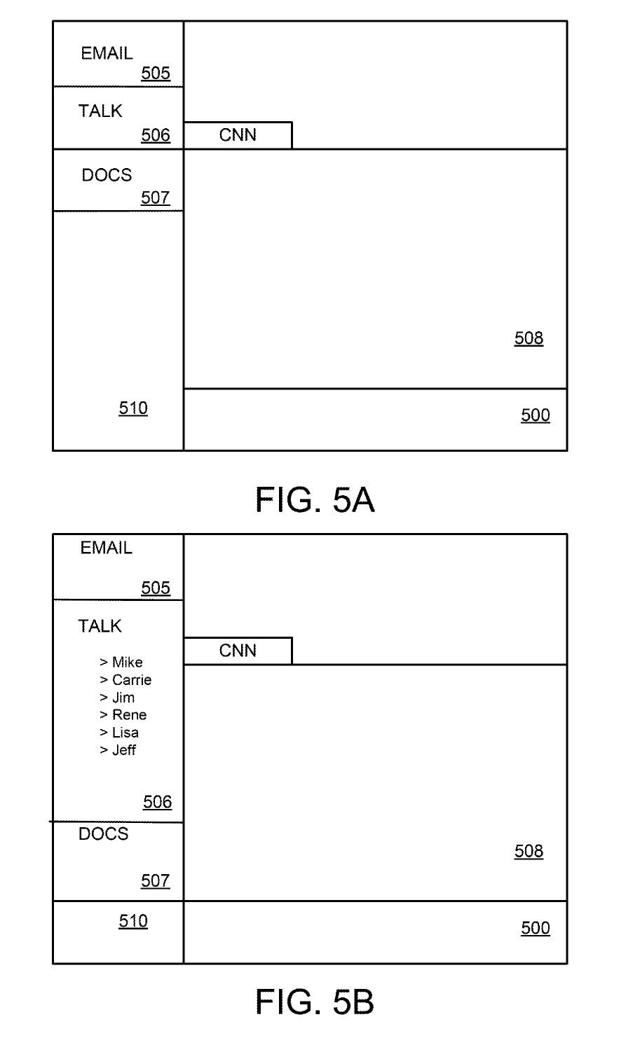

FIGS. 5A and 5B are a schematic illustration of a desktop user interface that contains a plurality of expandable and collapsible panels vertically stacked in a panel bar. In an example operating system (OS), each tab in a tabbed web browser can be treated as a separate windowing element and can have all the attributes, priorities and privileges of the web browser itself. Consequently, tabs in the web browser can be separated from the browser and docked to an edge of the desktop user interface as a panel in a panel bar. The panels can be vertically stacked along a side of the screen in a vertical panel bar, or horizontally displayed at the top or bottom of the screen in a horizontal panel bar.

As shown in FIG. 5A, Email 505 (which may be an email application), Talk 506 and Docs 507 applications can be vertically stacked as a series of panels in a vertical Panel Bar 510 of a desktop user interface 500. Vertical Panel Bar 510 can be displayed at the left edge of user interface 500 as shown in the figures, or along the right edge of user interface 500 (not shown). As with the panels in an application user interface, the panels in a desktop user interface can be automatically expanded and collapsed by an operating system based on a user's activity within the user interface. The automatic expansion and collapse of panels within a desktop user interface can occur in the same manner as the automatic expansion and collapse of panels within an application user interface (e.g., the “Inbox”, “Contacts”, “Tasks” and “Drafts” panels in the web-based email application) as described above. As the user interacts with objects on the desktop (e.g., drags a pointing device across the objects on the desktop), the operating system can use information about the current position and movement of the cursor or pointing device, for example, to automatically expand a panel in the Panel Bar 510. For example, the operating system can expand a panel when a user selects it (e.g., clicks on it), and can automatically collapse other panels within the desktop user interface in order to provide the user with a deeper view into the selected panel. Moreover, the operating system can expand a panel when the user scrolls past the title of the panel, or when the operating system and/or browser determines that at least one information element within the panel becomes displayable within the user interface. Similarly, the operating system can automatically collapse a panel in the Panel Bar 510 when the user has scrolled past the last information element in the panel, or when the operating system and/or browser determines that none of the information elements within the panel are currently displayable.

As shown in FIG. 5B, when the operating system automatically expands a panel, such as the “Talk” panel 506, the individual information elements that are contained within that panel are revealed. For example, when a user scrolls past the “Talk” panel 506, the operating system can automatically expand the “Talk” panel 506 to reveal a number of recent chats the user has had with other users. The information revealed can include, for example, the person with whom the user chatted and the date and time (not shown) of the chat. Other information could also be revealed, such as the duration of the chat and the content of the chat itself. When different panels are expanded, different information elements can be revealed. For example, if the operating system and/or browser automatically expanded the “Docs” panel 507, the expanded panel could reveal a list of documents the user has recently opened, saved, created, edited, copied, renamed or viewed. And, as discussed above, were the user to scroll up and through all of the information elements in the “Talk” panel 506, the operating system could automatically collapse the “Talk” panel 506 and expand the “Email” panel 505. Once expanded, the “Email” panel 505 could reveal a list of email messages the user has recently sent or received.

According to an example implementation, a panel may be moved to different locations within a display area. For example, a panel may be associated with (or coupled to) and disassociated from (or decoupled from) web pages, and may be converted from a panel to a tabbed web page (and vice versa). Also, a panel may be docked to a panel bar and may be undocked from the panel bar, for example. Panels may include elements, such as elements or portions of a web page, that may be selected by a user, e.g. via a mouse or pointing device, and moved to different locations. Panels may include, as some examples, applications, web pages, a task list, a buddy list or contact list, a chat roster, an email application (e.g., Email web based email application), a video search and display application window, social media applications, a window for a text or document and other user generated content, a pop-up window, a weather panel that provides weather information, etc. A panel, at least in some cases, may be displayed as a small window or mini web page that is smaller than a full-size web page or window when displayed.

For example, a browser may recognize and display a panel within a tabbed page, or may move (e.g., based upon user input) the panel to a different page or application, and the user may associate (or couple or embed) the panel to the new page or application. In another example, a user interested in a particular panel in a tabbed page that is crowded with less useful information can select the panel of interest, and dock it to the left of the browser (e.g., dock it to a vertical panel bar on the desktop), dock it to a horizontal panel bar on a desktop or dashboard at the bottom of a desktop interface, or elevate (or move) the panel to its own tab (e.g., displaying the panel as its own tabbed page) within the browser. These are merely illustrative examples and are not meant to limit the implementations described in this disclosure.

A panel, e.g., in the case of a web page, may include an associated block of HTML (Hypertext Markup Language) code (or code provided in another language) with an attribute of “extractable” (or “movable”), for example, which may indicate to the web browser that this panel and associated HTML code may be disassociated (or decoupled or extracted) from other web pages or windows, and moved to other locations, and may even be associated (or coupled) to a new web page, window or application, for example.

In an example implementation, a movable panel may be associated with (or coupled to or embedded within) a page or window where the panel is provided at a fixed location. For example, when a panel is associated with a web page, the panel may cover up a portion of the web page where it resides, and the panel may be provided at a static or fixed location such that the panel may move with the associated web page. The panel may be disassociated (or decoupled) from the page or window, e.g., when a user selects a “pop-out” (or disassociate) area or portion of the panel, which may cause the panel to pop-out or be disassociated (or extracted) from the page or window, allowing the panel to move with respect to the page or window, fore example. In other example implementations, a panel may be disassociated (or decoupled) by a user selecting a “pop-out” menu option using a mouse, keyboard or other pointing device, or by simply selecting the panel and dragging the panel to a new location. Similarly, a panel may be associated with (or coupled to) a web page by selecting a “pop-in” (or associate) area or button of the panel, by selecting a “pop-in” menu option, or by simply dragging and dropping the panel onto the web page or application to which the panel is being associated with.

A panel may exist as part of a web page (associated with the web page), or as a disassociated panel. A panel may also be docked to a panel bar, which may be located anywhere on a desktop, e.g., horizontal panel bar at an upper or lower edge, or a vertical panel bar. Also, panels may be created or opened based on an address or link or URL (Uniform Resource Locator). For example, a panel may be opened or created by typing in the address or link to the panel in an application (such as a web browser), or by selecting or clicking on a link to the panel. Once created or opened, the panel may be moved to various locations, associated with a web page, docked to a panel bar, converted to a tabbed web page, etc.

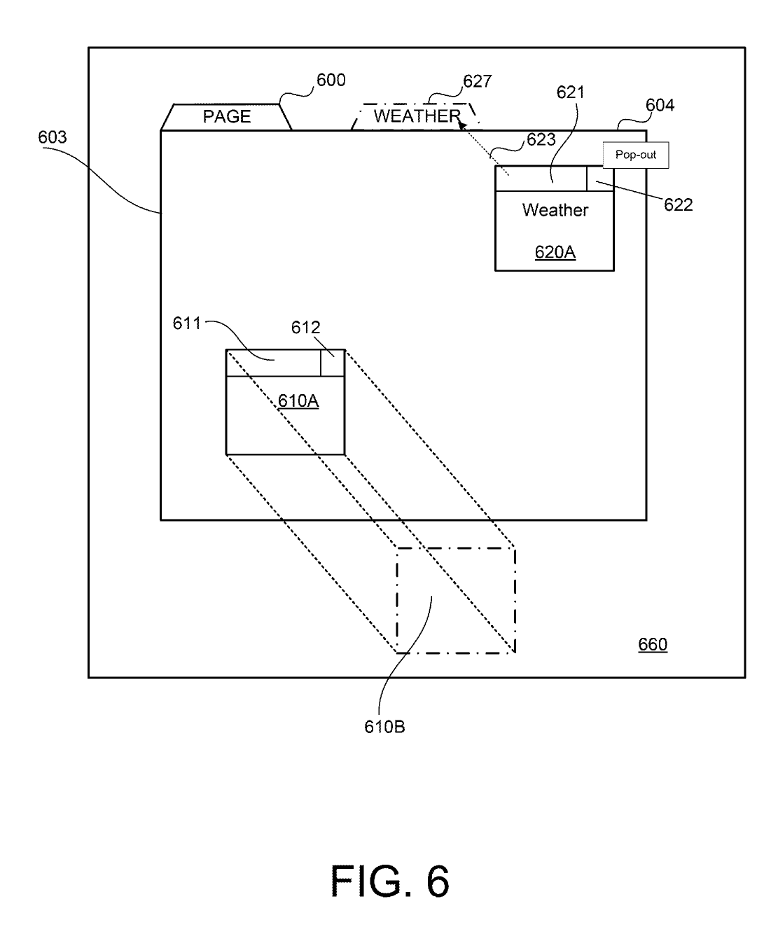

FIG. 6 is a block diagram illustrating panels according to an example implementation. A browser window 603 may be provided (or displayed) on (or within the boundary of) a computer display area 660. The browser window 603 may include a tabbed web page 600. Other tabbed web pages may be provided, and one of the web pages may be displayed when the associated tab is selected, for example. A panel 620A may be coupled to (or embedded within) the page 600. Panel 620A may be, for example, a weather panel 620A that may include a block of HTML code to display weather information for San Jose, Calif., for example. A panel 610A may also be provided, and may be a video panel to show or display a video.

Panel 620A may include an area or region, such as a pop-out area 622 (or pop-out button) that may allow a user to pop-out or disassociate (or decouple) the panel 620A from the web page 600, and allow the panel to move with respect to web page 600. Panel 620A may include a draggable area 621, where a user may select this draggable area 621 to drag or move the panel 620A to a different location, e.g., via a drag-and-drop operation, for example once the panel 620A has been popped-out or decoupled. Similarly, panel 610A may include a pop-out area 612 to allow a user to pop-out or disassociate the panel from web page 600, and a draggable area 611 that may allow a user to select to move the panel 610A via a drag-and-drop operation once the panel 610A has been popped-out or decoupled. Panels 610A and 620A may be smaller than the tabbed web page 600 or the browser window 603.

Alternatively, a panel may be associated or disassociated from a web page or application based on a selection of a menu option for the panel, e.g., an associate (or “pop-in”) menu option, or a disassociate (or “pop-out”) menu option. In another example implementation, it may not be necessary to disassociate a panel from a web page using a pop-out area or a pop-out menu command. Rather, the panel may be disassociated from a web page when the panel is selected and dragged using a pointing device, for example. In this example, therefore, a separate disassociate (or pop-out) operation is not necessary, as the panel may simply be dragged and dropped to a new location. Similarly, in one example implementation, a panel may be associated with a web page or application by dragging and dropping the panel onto the web page or application window.

In an example implementation, when a panel is associated with a web page, the web page or browser window, the panel may be (or may be considered to be) a part of the browser window or web page, and the web page may control the panel, e.g., adjust or control its size, location, appearance, and may control other qualities of the panel. Once the panel has been disassociated from a web page, communication may still occur between the (previously associated) web page and the panel, but the web page may not typically control the panel. For example, after disassociating a chat roster panel from an email web page, communication may still occur between the chat roster and the email application (e.g., to perform updates on one based on changes to the other), but the chat roster characteristics may not typically be controlled by the email application.

In an example implementation, a user may select pop-out area 612 to pop-out or disassociate (or decouple) the panel 610A from web page 600. The user may then select the draggable area 611 to drag the panel 610A (via a drag-and-drop operation) outside of the browser window 603 and web page 600 to a new location 610B on display area 660. The panel may be placed at a desired location on the desktop, and may then be associated with a different web page, may be docked to a panel bar or the desktop, or may be converted to a tabbed web page, as examples.

In another example implementation, a user may select pop-out area 622 of panel 620A to pop-out or disassociate the panel 620A from web page 600. The user may then select the draggable area 621 and pull or drag the information element (as shown by line 623) up to a tab strip 504 of the browser 603 and tabbed web page 600 where one or more tabs are located, or will be located. This may cause the browser to automatically display the panel 520A as a tabbed web page, e.g., at the same level as tabbed page 500. For example, dragging the panel to the tab strip 604 and dropping the panel over or near the tab strip 604 may cause the panel 620A to be converted to a tabbed web page, e.g., where the size of the panel 620A may be increased in size and a tab 627 (in this example, “Weather”) for such web page may be added to the tab strip 604.

Alternatively or additionally, a panel may be converted to a tabbed web page by clicking on a panel or by selecting a “convert to tabbed web page” menu option for the panel. As noted, converting a panel to a tabbed web page may include, for example, increasing a size (or adjusting a size) of the panel and adding a tab to the tab strip for the panel. In various implementations, tabbed web pages may be converted back into smaller panels as well. Further, a panel may be moved between application windows.

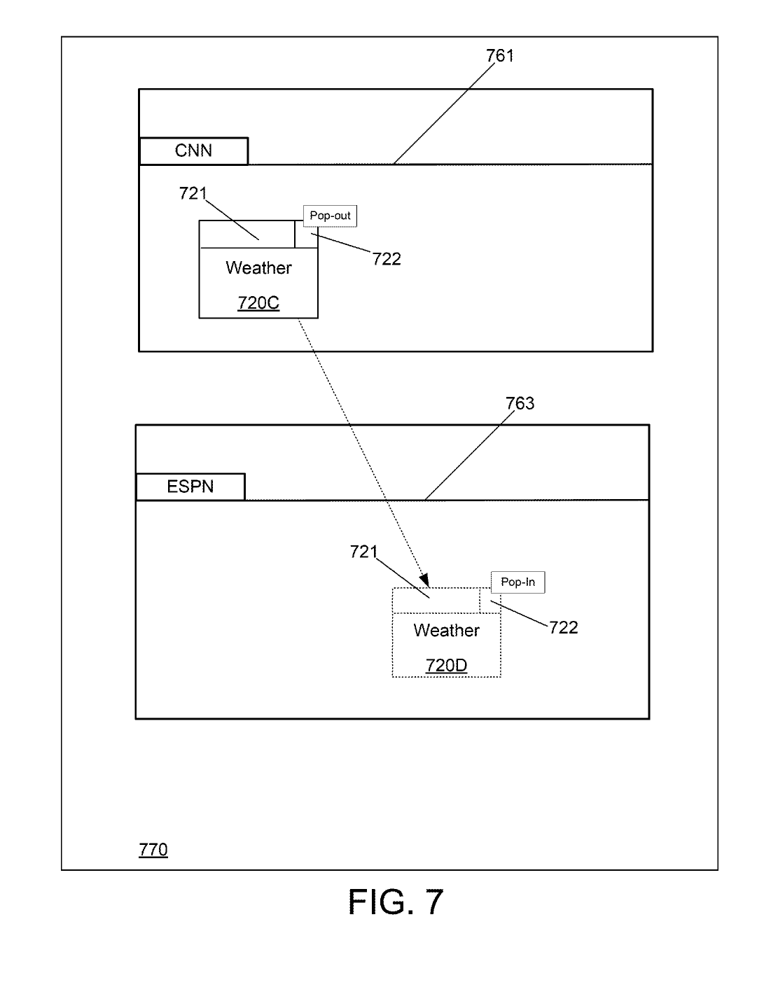

FIG. 7 is a diagram illustrating moving a panel from a first application window to a second application window according to an example implementation. In this example, two application windows are shown on a display area 770. The application windows may be for different applications (e.g., web page for a first window, and a Word or text document for a second window), or may be two windows of a same type of application, e.g., two web pages. In this example, two application windows are shown as two web pages including a CNN web page 761 and an ESPN web page 763. A panel 720C is coupled to (or embedded within) the CNN web page 761. A user may select the pop-out area 722 of panel 720C to disassociate the panel from the web page 761. The user may then drag or move the panel 720C beyond or outside the CNN web page 761, across the display area 770 to the ESPN web page 763. Panel 720C, after being moved to ESPN web page 763, is shown as panel 720D, where panels 720C and 720D may be the same panel, but at different locations as shown in FIG. 7.

In this manner, the panel 720C may be displayed at a first location within a boundary of a first application window (e.g., within web page 761). The panel 720C may be moved, e.g., via a drag-and-drop operation in accordance with user input (e.g., based on user motion/movement of a mouse or other pointing device), to a second location (shown as 720D) within a boundary of a second application window, e.g., within web page 763.

The user may then select the “pop-in” area 722 of the panel 720D to pop-in (or associate) the panel 720D to the ESPN web page 763 (e.g., where the panel 720D may not move without popping it out again). The area 722 may, in an example implementation, toggle the panel between pop-out (disassociate or decouple) and pop-in (associate or couple).

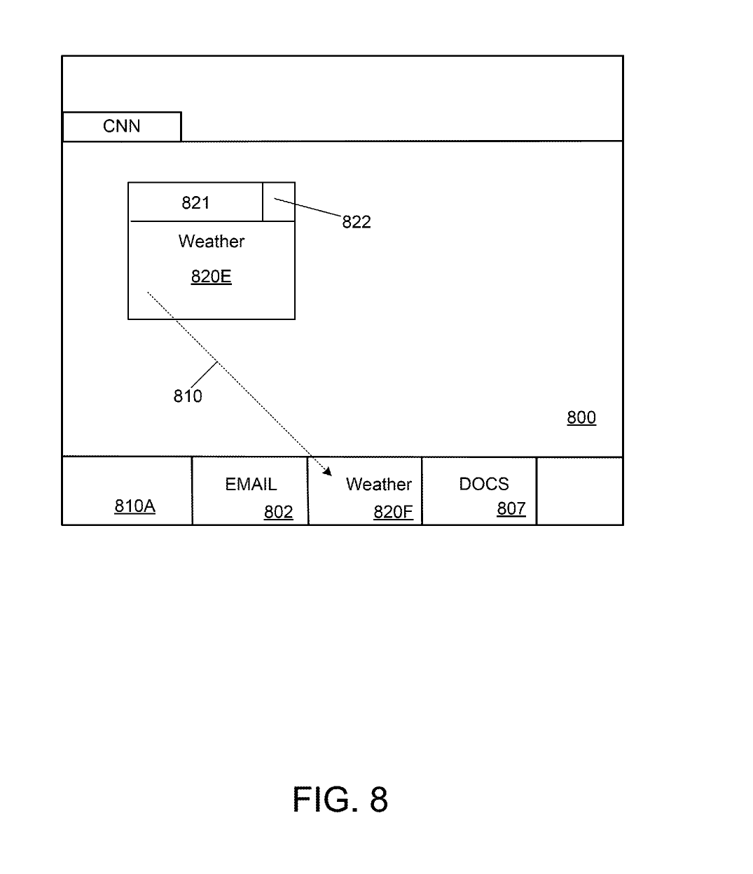

FIG. 8 is a diagram illustrating docking a panel to a horizontal panel bar according to an example implementation. In this example, a panel 820E may be provided on or within a web page 821. A horizontal panel bar 810A is provided on a user interface, which may be provided on a desktop. The horizontal panel bar 810A may include a plurality of panels docked (or attached) thereto (or included therein), including an EMAIL panel 802, a DOCs panel 907, etc. The weather panel 820E is provided within the tabbed web page 821, and may be associated to the web page 821. When associated with the web page 821, panel 820E may be a part of the web page 821, and may be provided at a fixed or static location on the web page, where the panel moves when the web page moves. A user may disassociate (or decouple) the weather panel 820E from the web page 821 (e.g., by selecting the pop-out area 822, by using a pop-out menu command, or by simply selecting and dragging the panel), and then move (e.g., via drag-and-drop operation shown by line 810) the panel 820E outside of web page 821 to horizontal panel bar 810A. In an example implementation, when the panel reaches the panel bar 810A (e.g., makes contact with, or comes within a threshold distance of the panel bar 810A) the panel 820E is automatically (e.g., without user selecting pop-in area 822) docked to the panel bar 810A as panel 820F. The docked weather panel is shown as weather panel 820F included within panel bar 810A. In an example implementation, docking may include attaching the panel to other panels within the panel bar 810A, or including the panel within the panel bar 810A. Alternatively, after the panel 820E reaches panel bar 810A, a user may select pop-in area 822 (or other command) to dock (or attach) the panel 820E to the panel bar 810A (docked panel shown as weather panel 820F).

The docking may include the processor or browser reducing a size of the docked panel to allow the panel bar 810A to accommodate a plurality of panels, and then attaching the reduced panel to the panel bar. For example, as more panels are docked or attached to the panel bar 810A (e.g., more docked panels squeezed into a same size panel bar), the size (e.g., width) of each panel docked to the horizontal panel bar 810A may be decreased. Thus, the size of the panel 820E may be decreased or reduced for docking the panel to the panel bar. For example, panel 820F that is docked to the panel bar 810A may be smaller than the panel 820E that is not docked to the panel bar. One skilled in the art will understand that panel bar 810A may be vertical or grouped in any type of configuration within a display area 800.

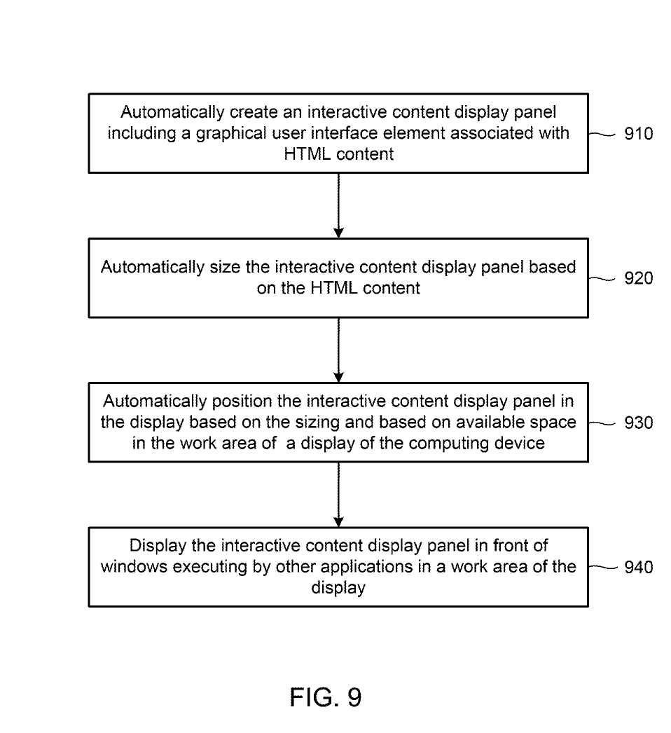

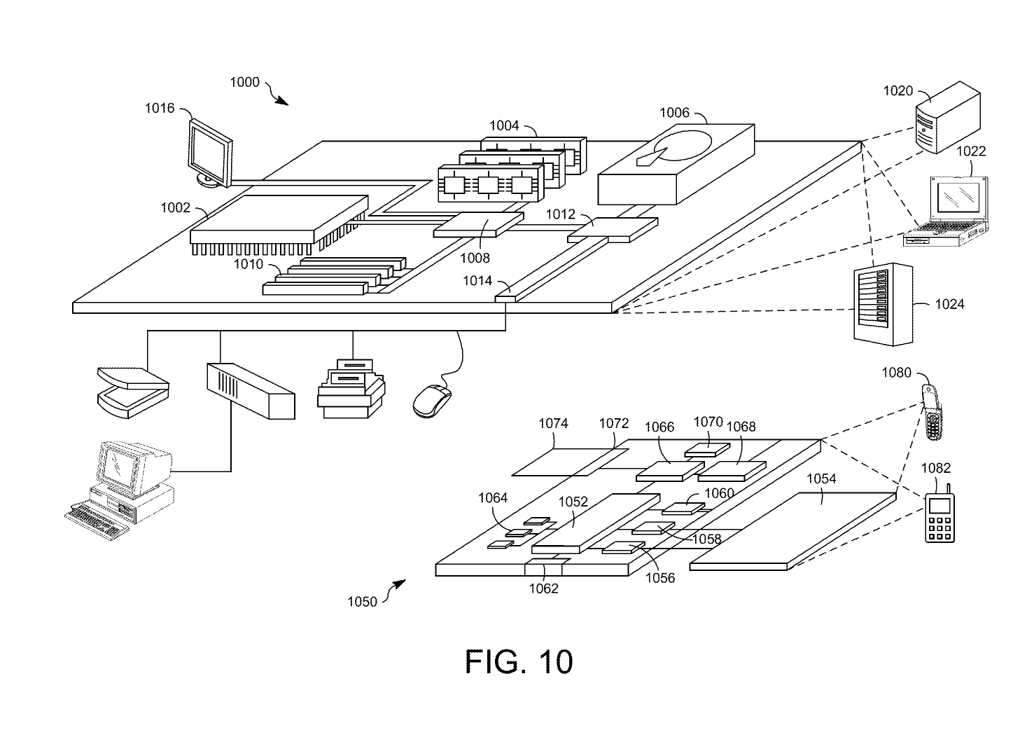

FIG. 9 is a flow diagram illustrating a process for managing interactive content display panels. The process 900 depicted in FIG. 9 may be performed by processor of a computing device, as described in more detail below with respect to FIG. 10. As shown in FIG. 9, the processor may automatically create an interactive content display panel including a graphical user interface element associated with HTML content (910). The graphical user interface element may be one of panels 150, 160, 170, or 180 as shown in FIG. 1, for example, and the HTML content may include the content shown in panels 150, 170, and 180, such as chat messages or tasks. The processor may automatically size the interactive content display panel based on the HTML content (920), and may automatically position the interactive content display panel in the display (e.g., in work area 110 shown in FIG. 1), base don available space in the work area of the display. The processor may display the interactive content display panel in front of (“on top of”) windows executing by other applications in a work area of the display (940).

FIG. 10 shows an example of a generic computer device 1000 and a generic mobile computer device 1050, which may be used with the techniques described in FIGS. 1-9. Computing device 1000 is intended to represent various forms of digital computers, such as laptops, desktops, workstations, personal digital assistants, servers, blade servers, mainframes, and other appropriate computers. Computing device 1050 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 1000 includes a processor 1002, memory 1004, a storage device 1006, a high-speed interface 1008 connecting to memory 1004 and high-speed expansion ports 1010, and a low speed interface 1012 connecting to low speed bus 1014 and storage device 1006. Each of the components 1002, 1004, 1006, 1008, 1010, and 1012, are interconnected using various busses, and may be mounted on a common motherboard or in other manners as appropriate. The processor 1002 can process instructions for execution within the computing device 1000, including instructions stored in the memory 1004 or on the storage device 1006 to display graphical information for a GUI on an external input/output device, such as display 1016 coupled to high speed interface 1008. In other implementations, multiple processors and/or multiple buses may be used, as appropriate, along with multiple memories and types of memory. Also, multiple computing devices 1000 may be connected, with each device providing portions of the necessary operations (e.g., as a server bank, a group of blade servers, or a multi-processor system).

The memory 1004 stores information within the computing device 1000. In one implementation, the memory 1004 is a volatile memory unit or units. In another implementation, the memory 1004 is a non-volatile memory unit or units. The memory 1004 may also be another form of computer-readable medium, such as a magnetic or optical disk.

The storage device 1006 is capable of providing mass storage for the computing device 1000. In one implementation, the storage device 1006 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1004, the storage device 1006, or memory on processor 1002.

The high speed controller 1008 manages bandwidth-intensive operations for the computing device 1000, while the low speed controller 1012 manages lower bandwidth-intensive operations. Such allocation of functions is exemplary only. In one implementation, the high-speed controller 1008 is coupled to memory 1004, display 1016 (e.g., through a graphics processor or accelerator), and to high-speed expansion ports 1010, which may accept various expansion cards (not shown). In the implementation, low-speed controller 1012 is coupled to storage device 1006 and low-speed expansion port 1014. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1000 may be implemented in a number of different forms, as shown in the figure. For example, it may be implemented as a standard server 1020, or multiple times in a group of such servers. It may also be implemented as part of a rack server system 1024. In addition, it may be implemented in a personal computer such as a laptop computer 1022. Alternatively, components from computing device 1000 may be combined with other components in a mobile device (not shown), such as device 1050. Each of such devices may contain one or more of computing device 1000, 1050, and an entire system may be made up of multiple computing devices 1000, 1050 communicating with each other.

Computing device 1050 includes a processor 1052, memory 1064, an input/output device such as a display 1054, a communication interface 1066, and a transceiver 1068, among other components. The device 1050 may also be provided with a storage device, such as a microdrive or other device, to provide additional storage. Each of the components 1050, 1052, 1064, 1054, 1066, and 1068, are interconnected using various buses, and several of the components may be mounted on a common motherboard or in other manners as appropriate.

The processor 1052 can execute instructions within the computing device 1050, including instructions stored in the memory 1064. The processor may be implemented as a chipset of chips that include separate and multiple analog and digital processors. The processor may provide, for example, for coordination of the other components of the device 1050, such as control of user interfaces, applications run by device 1050, and wireless communication by device 1050.

Processor 1052 may communicate with a user through control interface 1058 and display interface 1056 coupled to a display 1054. The display 1054 may be, for example, a TFT LCD (Thin-Film-Transistor Liquid Crystal Display) or an OLED (Organic Light Emitting Diode) display, or other appropriate display technology. The display interface 1056 may comprise appropriate circuitry for driving the display 1054 to present graphical and other information to a user. The control interface 1058 may receive commands from a user and convert them for submission to the processor 1052. In addition, an external interface 1062 may be provided in communication with processor 1052, so as to enable near area communication of device 1050 with other devices. External interface 1062 may provide, for example, for wired communication in some implementations, or for wireless communication in other implementations, and multiple interfaces may also be used.

The memory 1064 stores information within the computing device 1050. The memory 1064 can be implemented as one or more of a computer-readable medium or media, a volatile memory unit or units, or a non-volatile memory unit or units. Expansion memory 1074 may also be provided and connected to device 1050 through expansion interface 1072, which may include, for example, a SIMM (Single In Line Memory Module) card interface. Such expansion memory 1074 may provide extra storage space for device 1050, or may also store applications or other information for device 1050. Specifically, expansion memory 1074 may include instructions to carry out or supplement the processes described above, and may include secure information also. Thus, for example, expansion memory 1074 may be provided as a security module for device 1050, and may be programmed with instructions that permit secure use of device 1050. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1064, expansion memory 1074, or memory on processor 1052, that may be received, for example, over transceiver 1068 or external interface 1062.

Device 1050 may communicate wirelessly through communication interface 1066, which may include digital signal processing circuitry where necessary. Communication interface 1066 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1068. In addition, short-range communication may occur, such as using a Bluetooth, WiFi, or other such transceiver (not shown). In addition, GPS (Global Positioning System) receiver module 1070 may provide additional navigation- and location-related wireless data to device 1050, which may be used as appropriate by applications running on device 1050.

Device 1050 may also communicate audibly using audio codec 1060, which may receive spoken information from a user and convert it to usable digital information. Audio codec 1060 may likewise generate audible sound for a user, such as through a speaker, e.g., in a handset of device 1050. Such sound may include sound from voice telephone calls, may include recorded sound (e.g., voice messages, music files, etc.) and may also include sound generated by applications operating on device 1050.

The computing device 1050 may be implemented in a number of different forms, as shown in the figure. For example, it may be implemented as a cellular telephone 1080. It may also be implemented as part of a smart phone 1082, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method for managing information displayed on a computing device, comprising:
automatically creating, using an application executed by a processor of the computing device, an interactive content display panel, wherein the interactive content display panel includes a graphical user interface element associated with HTML content; and
displaying the interactive content display panel in front of all other windows displayed in a work area of a display of the computing device, wherein the displaying includes:
automatically adjusting the size the interactive content display panel, based on updates to the HTML content; and
automatically positioning the interactive content display panel in the display, based on the automatic adjustment of the size of the interactive content display panel and based on available space in the work area of the display.

2. The method of claim 1, wherein the available space is determined based on the size of the other windows executing by applications in the work area of the display.

3. The method of claim 1, further comprising automatically adjusting a width of the interactive content display panel based upon a dimension of content displayed as a result of execution of the HTML content.

4. The method of claim 1, wherein the application is a browser application.

5. The method of claim 1, further comprising:
creating multiple interactive content display panels at a predetermined rate.

6. The method of claim 5, further comprising limiting the number of multiple interactive content display panels to a predetermined number based on a type of originating application creating the multiple interactive content display panels.

7. The method of claim 1, further comprising automatically resizing the interactive content display panel based on a resolution of the display.

8. The method of claim 1, further comprising:
moving, by the processor via a drag-and-drop operation, a location of the interactive content display panel to a tab strip of a web browser interface where one or more tabs are located; and
displaying the interactive content display panel as a second tabbed web page of the web browser interface, based on the moving.

9. The method of claim 1, further comprising:
grouping the interactive content display panel with other interactive content display panels in a panel bar in an area of the display above a task bar.

10. The method of claim 9, further comprising:
automatically moving the panel bar, based on a movement of the task bar.

11. The method of claim 9, further comprising: displaying each of the interactive content display panels in the panel bar created by a certain application using a single background color.

12. The method of claim 9, further comprising:
automatically adding a new interactive content display panel to the panel bar.

13. The method of claim 1, further comprising:
grouping the interactive content display panel with other interactive content display panels if the application is the same as an originating application of the other interactive content display panels.

14. The method of claim 9, further comprising:
making the other interactive content display panels in the grouping available using a scroll bar.

15. The method of claim 9, further comprising:
allowing an operation to be performed on two or more interactive content display panels in the grouping at the same time.

16. The method of claim 15, wherein the operation includes: moving, minimizing, expanding, or closing the two or more interactive content display panels.

17. The method of claim 1, where a vertical height of the interactive content display panel is automatically adjusted based on the HTML content of the interactive content display panel.

18. The method of claim 1, further comprising:
automatically adjusting a size of the interactive content display panel based upon a change in a screen size of the work area.

19. A non-transitory computer readable medium having recorded and stored thereon instructions that, when executed by a processor of a computer system, cause the computer system to:
automatically create, using an application executed by a processor of the computing device, an interactive content display panel, wherein the interactive content display panel includes a graphical user interface element associated with HTML content; and
display the interactive content display panel in front of all other windows displayed in a work area of a display of the computing device, wherein the displaying includes:
automatically adjusting the size the interactive content display panel, based on updates to the HTML content; and
automatically positioning the interactive content display panel in the display, based on the automatic adjustment of the size of the interactive content display panel and based on available space in the work area of the display.

20. A system comprising:
a display;
a memory configured to store executable code; and
a processor operably coupled to the memory, the processor configured to execute the code to:
automatically create, using an application executed by a processor of the computing device, an interactive content display panel, wherein the interactive content display panel includes a graphical user interface element associated with HTML content; and
display the interactive content display panel in front of all other windows displayed in a work area of a display of the computing device, wherein the displaying includes:
automatically adjusting the size the interactive content display panel, based on updates to the HTML content; and
automatically positioning the interactive content display panel in the display, based on the automatic adjustment of the size of the interactive content display panel and based on available space in the work area of the display.
